(19) United States
(12) Patent Application Publication
(10) Pub. No.: US 2025/0372595 A1
(43) Pub. Date: Dec. 4, 2025

(54) PROCESS OF PREPARATION OF DRY ELECTRODE AND IMPLEMENTATIONS THEREOF

(71) Applicant: OLA ELECTRIC MOBILITY LIMITED, Karnataka (IN)

(72) Inventors: Mohamed Shakeel AKHTER, Karnataka (IN); Guruprasad S. HEGDE, Karnataka (IN); Akhil DILEEP, Karnataka (IN); Lakshmi K P, Karnataka (IN); Rajesh KUPPUSAMY, Karnataka (IN); Amlan ROY, Karnataka (IN); Ramesha R N, Karnataka (IN); Neelakshi SHARMA, Karnataka (IN); Rajesh MEKKAT, Karnataka (IN)

(21) Appl. No.: 18/869,784

(22) PCT Filed: Sep. 1, 2023
(86) PCT No.: PCT/IN2023/050829

§ 371 Date: Nov. 26, 2024

(30) Foreign Application Priority Data
Nov. 21, 2022 (IN) 202241066825

(51) Int. Cl. H01M 4/04; B01F 23/50; B01F 23/53; B01F 23/57; B01F 23/80; H01M 4/583; H01M 4/62

(52) U.S. Cl. CPC H01M 4/0435; B01F 23/511; B01F 23/53; B01F 23/57; B01F 23/801; B01F 23/802; H01M 4/583; H01M 4/623; H01M 4/625; B01F 2215/0472; B01F 2215/0477; B01F 2215/0481

(57) ABSTRACT

The present disclosure provides a process for preparing an electrode, the process comprising: (a) mixing an active material, and a conductive additive, optionally with a first binder to obtain a first mixture; (b) blending a fibrillating binder with the first mixture, followed by high shear mixing to obtain a second mixture; and (c) quenching the second mixture and calendering to obtain the electrode.

### FIELD OF THE INVENTION

The present disclosure broadly relates to the field of batteries. Particularly, the present disclosure relates to the process for fabricating the electrode, more particularly the present disclosure relates to processes of preparing dry electrodes.

### BACKGROUND OF THE INVENTION

With increasing global demand for batteries, developing efficient fabrication methods is a prime focus in the field of battery manufacturing. Secondary batteries are the majorly used power source for electronic devices, vehicles, etc. Extensive research is carried out to improve various parts of the secondary batteries in order to maximize the energy density with low cost.

An active material is coated upon the current collector to form the electrode in a battery. The active material is the site of electrochemical reactions, facilitating the electrode to store and release energy upon cell discharge. The electrode composition comprising an active material and a conductive carbon is dissolved in a solvent to form a liquid slurry that is applied to the top of the current collector. After the coating, they are dried and fabricated as electrodes. Drying electrodes after the slurry coating is a tedious, costly, time-consuming and energy demanding process in the secondary cell production. Moreover, use of certain organic solvents in the slurry is toxic and involves energy intensive measures for their recovery. In order to address these drawbacks, wet coating has recently been replaced with dry coating, wherein no solvent is employed. Alternatively, in dry electrode compositions polymeric binders with fibrillation properties are used along with the active material to counter the drying issue. Binder fibrillation is one of the commonly adopted industrial technologies for dry coating where the binder is fibrillated under shear conditions and the fibrils of the binder acts as a web to hold the active materials and forms a free-standing film after calendering.

Thus, there is a dire need in the art to develop a cost-effective, compatible, and improved process for effective binder fibrillation for preparation of dry electrode.

### SUMMARY OF THE INVENTION

In a first aspect of the present disclosure, there is provided a process for preparing an electrode, the process comprising: (a) mixing an active material, a conductive additive, optionally with a first binder to obtain a first mixture; (b) blending a fibrillating binder with the first mixture, followed by high shear mixing to obtain a second mixture; (c) quenching the second mixture and calendering to obtain the electrode.

In a second aspect of the present disclosure, there is provided an electrode obtained by the process as disclosed herein.

In a third aspect of the present disclosure, there is provided a first electrochemical cell comprising: (a) an anode comprising the electrode obtained by the process disclosed herein; (b) a cathode; and (c) an electrolyte.

In a fourth aspect of the present disclosure, there is provided a second electrochemical cell comprising: (a) an anode; (b) a cathode comprising the electrode obtained by the process as disclosed herein; and (c) an electrolyte.

In a fifth aspect of the present disclosure, there is provided a modified electrochemical cell comprising: (a) an anode comprising the electrode obtained by the process as disclosed herein; (b) a cathode comprising the electrode obtained by the process as disclosed herein; and (c) an electrolyte.

These and other features, aspects, and advantages of the present subject matter will be better understood with reference to the following description and appended claims. This summary is provided to introduce a selection of concepts in a simplified form. This summary is not intended to identify key features or essential features of the claimed subject matter, nor is it intended to be used to limit the scope of the claimed subject matter.

### BRIEF DESCRIPTION OF THE FIGURES

The following drawings form a part of the present specification and are included to further illustrate aspects of the present disclosure. The disclosure may be better understood by reference to the drawings in combination with the detailed description of the specific embodiments presented herein.

FIG. 1 depicts the schematic representation of the processes of the preparation of electrode, in accordance with an embodiment of the present disclosure.

FIG. 2 depicts the pictorial representation of the rollers used for the calendering process which results in binder fibrillation, in accordance with an embodiment of the present disclosure.

FIG. 3 depicts the images of electrode films obtained from the disclosed process wherein the high shear mixing step was carried out at (a) high temperature (70° C.) and (b) low temperature (30° C.), in accordance with an embodiment of the present disclosure.

FIG. 4A depicts the scanning electron microscopic (SEM) images of the electrode material prepared by the process as disclosed herein after high shear mixing prior to calendering, in accordance with an embodiment of the present disclosure.

FIG. 4B depicts the SEM images of the electrode material prepared by the process as disclosed herein after calendering at 80° C., in accordance with an embodiment of the present disclosure.

FIG. 5 depicts the SEM images for the electrode material where the temperature was not controlled and went above 85° C., in accordance with an embodiment of the present disclosure.

### DETAILED DESCRIPTION OF THE INVENTION

Those skilled in the art will be aware that the present disclosure is subject to variations and modifications other than those specifically described. It is to be understood that the present disclosure includes all such variations and modifications. The disclosure also includes all such steps, features, compositions, and compounds referred to or indicated in this specification, individually or collectively, and any and all combinations of any or more of such steps or features.

### Definitions

For convenience, before further description of the present disclosure, certain terms employed in the specification, and examples are delineated here. These definitions should be read in the light of the remainder of the disclosure and understood as by a person of skill in the art. The terms used herein have the meanings recognized and known to those of skill in the art, however, for convenience and completeness, particular terms and their meanings are set forth below.

The articles “a”, “an” and “the” are used to refer to one or to more than one (i.e., to at least one) of the grammatical object of the article.

The terms “comprise” and “comprising” are used in the inclusive, open sense, meaning that additional elements may be included. It is not intended to be construed as “consists of only”.

Throughout this specification, unless the context requires otherwise the word “comprise”, and variations such as “comprises” and “comprising”, will be understood to imply the inclusion of a stated element or step or group of element or steps but not the exclusion of any other element or step or group of element or steps.

The term “including” is used to mean “including but not limited to”. “Including” and “including but not limited to” are used interchangeably.

The term “w/w” means the percentage by weight, relative to the weight of the total composition, unless otherwise specified. The term “at least one” is used to mean one or more and thus includes individual components as well as mixtures/combinations.

The term “active material” refers to the active constituent of an electrode, which comprises the particles that undergo oxidation or reduction, resulting in reversible ion storage. The active material of the present disclosure can be an anode material or a cathode material. The anode material includes but not limited to natural graphite, synthetic graphite, silicon-graphite composite, silicon-carbon composite, hard carbon, soft carbon, mixture of natural and synthetic graphite, mixture of synthetic, natural graphite and silicon, mixture of any types of graphite with hard and soft carbon, LTO (lithium titanium oxides), LTO composites, or combinations thereof. In the present disclosure the anode material is synthetic graphite. The cathode material includes but not limited to lithium cobalt oxide (LCO), lithium manganese oxide (LMO), lithium iron phosphate (LFP), lithium yttrium iron phosphate (LYP), lithium nickel manganese cobalt oxide, nickel rich lithium nickel manganese cobalt oxide, lithium nickel cobalt aluminium oxide (NCA), lithium nickel manganese oxide (LNMO), lithium manganese phosphate (LiMnPO₄), lithium cobalt phosphate (LiCoPO₄), lithium vanadium phosphate (LVP), LiMn₂O₄, spinel type alkali metal-transition metal oxides, phosphate type cathode materials (e.g., LiFePO₄), spinel type alkali metal-transition metal oxides (e.g., LiMn₂O₄), AMO₂ type oxides where A is an alkali metal, M is one or more different composition of transition metals (e.g., LiNi_{0.8}Mn_{0.1}Co_{0.1}O₂), or combinations thereof.

The term “current collector” refers to the electric bridging component which collects electrical current generated at the electrodes of electrochemical devices and connect with external circuits. For the purpose of the present disclosure, the current collector includes but not limited to copper foil, aluminium foil, carbon coated copper aluminium foils, primer coated copper aluminium foils, glossy copper foils, glossy aluminium foils, or combinations thereof.

The term “calendering” refers to the process of converting the bulk of a material such as polymer into sheets of specific thickness and texture by passing the material into a machine consisting of a fairly arranged group of heated counter rotating rollers. The process is carried out for incorporating desired properties to the material. In the present disclosure, the term calendering refers to the process by which the mixture is converted into sheet-like structures to involve effective fibrillation of the material and result in the enhanced electrical conductivity and capacity of the material for the electrode application in a battery.

The term “fibrillating” refers to the process of converting the bulk of a material in the form of thin fibrils for the enhanced property and texture-mediated effect. In the present disclosure, effective fibrillation is achieved through the calendering process. It is also possible to carry out the fibrillation process before the calendering process. In another aspect of the present disclosure, the process optionally employs a screw extruder for fibrillation of the dry electrode material mixture. In one more aspect, effective fibrillation process is carried out in either screw extruder as well as in the calender.

The term “first binder” refers to a type of the binder constituent of an electrode, which holds the active material particles within the electrode of a battery together to maintain a strong connection between the electrode and the contacts. These binding materials are generally inert and play a significant role in the processability of the battery. In the present disclosure, the first binder is selected from polyvinylidene fluoride (PVDF), poly(vinylidene fluoride-co hexafluoropropylene) (PVDF-HFP), polyfluoroxy alkanes (PFA), polyvinylfluoride (PVF), polyethylene (PE), polyethylene vinyl acetate (PEVA), polyurethane (PU), polypropylene rubber (PPR), ethylene propylene rubber (EPR), styrene butadiene rubber (SBR), styrene-ethylene-butylene-styrene rubber (SEBS), acrylonitrile butadiene styrene rubber (ABS), polyisobutylene (PIB), polyvinyl alcohol (PVA), phenoxy resin, polyethylene terephthalate (PET), nylon, polymethyl methacrylate (PMMA), polyvinyl chloride (PVC), polyphenylene sulphide (PPS), PEDOT: PSS, polystyrene (PS), pitch, tar, asphalt, bitumen, cellulose, cellulose acetate, methylcellulose, ethyl cellulose, hydroxypropyl cellulose (HPC), hydroxyethyl cellulose (HEC), cellulose nitrate, carboxymethylcellulose (CMC), carboxyethyl cellulose, carboxypropyl cellulose, carboxyisopropyl cellulose, sodium cellulose, sodium cellulose nitrate, sodium carboxyalkyl cellulose, or combinations thereof. The binders are optionally soluble in water and some binders are either partially soluble or insoluble in water. The terms “first binder”, “non-fibrillating binder”, “non-fibrillating first binder” are used interchangeably.

The term “fibrillating binder” refers to a type of the binder constituent of an electrode, which possess the ability to form small fibrils under the application of shear force. The fibrillating binder provides the mechanical integrity of the electrode during manufacturing and provide optimal dispersion and adhesion of the active material and conductive additive to the current collector. Examples of fibrillating binder in the present disclosure includes but not limited to polytetrafluoroethylene (PTFE), fluoroethylene vinyl ether (FEVE), polypropylene (PP), polyethylene oxide (PEO), fluorinated ethylene propylene (FEP), polyacrylonitrile (PAN), nanofiber carboxy methyl cellulose (CMC), cellulose nanofibers or combinations thereof.

The term “conductive additive” refers to the electrically conductive component facilitating the easy flow of electric current to the current collector. It could be an electrically conductive allotrope of carbon such as Graphene, SWCNT, MWCNT, carbon black, ketjen black 600JD, acetylene black, Super P C45, Super P C65, Super P C65T, ketjen black 300 or combinations thereof.

The term “throughput” refers to the length of the self-standing film coming out from the calendaring machine per unit time. In an aspect of the present disclosure, the calendaring of the quenched second mixture is carried out in the range of 5-150 m/min.

The term “mixer blade tip speed” refers to the tangential velocity of the mixer blade at its tip. It is a function of the RPM and diameter of the mixer blade. In case of a mixer/blender, tip speed=rotation speed×circumference of the mixer/blender (2πr), wherein r is the blade radius, and π is 3.14151. In an aspect of the present disclosure, the blade radius is 97.5 mm, the blade circumference is 2×3.14×97.5=612.3 mm. In one revolution the blade covers 612.3 mm. At 1000 revolutions per min the blade covers 1000×612.3 which is equal to 612300 mm or 612.3 m. In one second, the blade covers 612.3÷60=˜10.205 m. So, the tip speed is specified as the distance swept by the blade tip in one second which is ˜10 m/s in one experimental setup. As the blade diameter increases (as in large mixers), the rpm required to achieve the same tip speed will decrease as the larger blade radius has a higher circumference. In another aspect of the present disclosure, high shear mixing of a blend of a first mixture and a fibrillating binder is carried out at a mixer blade tip speed in a range of 30-38 ms⁻¹.

The term “induced temperature” refers to the temperature of a system attained through a particular process such as mixing, milling, shear force application etc. For the purpose of the present disclosure, the induced temperature refers to the temperature in a range of 50 to 85° C. attained through high shear mixing of a blend of a first mixture and a fibrillating binder at mixer blade tip speed in a range of 30-38 ms⁻¹.

The term “external heating” refers to increasing the temperature by external heating source. For the purpose of the present disclosure, the external heating is done during the high shear mixing of a blend of a first mixture and a fibrillating binder at mixer blade tip speed in a range of 30-38 ms⁻¹.

The term “quenching” refers to the process of cooling down or reducing the temperature of a system either by using external cooling devices or by gradual decrease in temperature. In an aspect of the present disclosure, the second mixture is quenched to a temperature in a range of 0 to 19° C. and optionally under a mixer blade tip speed of 6 to 11 ms⁻¹ during or after quenching. For the purpose of the present disclosure, the second mixture is quenched using a chiller.

The term “mixer blade tip speed” refers to the speed with which the blades of the mixer instrument rotates for mixing, blending and high shear mixing. In an aspect of the present disclosure, mixing an active material, and a conductive additive optionally with a first binder is carried out at a at a mixer blade tip speed in a range of 14 to 20 ms⁻¹.

Ratios, concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, temperature in the range of 50 to 85° C. should be interpreted to include not only the explicitly recited limits of 50 to 85° C. but also to include sub-ranges, such as 55 to 60° C., 65 to 75° C. and so forth, as well as individual amounts, including fractional amounts, within the specified ranges, such as 60° C., 75.5° C., and 79.99° C.

Unless defined otherwise, all technical and scientific terms used herein have the same meaning as commonly understood by one of ordinary skill in the art to which this disclosure belongs. Although any methods and materials similar or equivalent to those described herein can be used in the practice or testing of the disclosure, the preferred methods, and materials are now described. All publications mentioned herein are incorporated herein by reference.

The present disclosure is not to be limited in scope by the specific embodiments described herein, which are intended for the purposes of exemplification only. Functionally equivalent products, compositions, formulations, and methods are clearly within the scope of the disclosure, as described herein.

As discussed in the background, many challenges exist in developing an efficient electrode via wet fabrication process. The existing wet processes for the development of electrodes are time consuming and incurs high costs. Further, the processes are tedious to be developed in large scale. In view of the existing shortcomings in electrode preparation processes, the present disclosure provides processes for preparing dry electrodes which could be easily adaptable for large scale development of this electrodes with minimal cost and energy. The process disclosed in the present disclosure enables to prepare the electrodes with no solvent and at optimal temperature conditions. Accordingly, the present disclosure provides a process for preparing an electrode, the process comprising: (a) mixing an active material, and a conductive additive optionally with a first binder to obtain a first mixture; (b) blending a fibrillating binder with the first mixture, followed by high shear mixing to obtain a second mixture; (c) quenching the second mixture and calendering to obtain the electrode.

In an embodiment of the present disclosure, there is provided a process for preparing an electrode, the process comprising: (a) mixing an active material, and a conductive additive at a temperature in a range of 0 to 30° C., at a mixer blade tip speed in a range of 11 ms⁻¹ to 20 ms⁻¹ for a time period in the range of 10 to 180 min, optionally with a first binder to obtain a first mixture; (b) blending a fibrillating binder with the first mixture at a mixer blade tip speed in a range of 9 to 11 ms⁻¹, followed by high shear mixing at a mixer blade tip speed in a range of 30 to 38 ms⁻¹ to obtain a second mixture; (c) quenching the second mixture at a mixer blade tip speed in a range of 6 to 11 ms⁻¹ and calendering to obtain the electrode. In another embodiment of the present disclosure, when the electrode is an anode, mixing an active material, and a conductive additive is carried out at a mixer blade tip speed in a range of 15 ms−1 to 19 ms⁻¹ for a time period in a range of 10 to 30 minutes. In still another embodiment of the present disclosure, when the electrode is a cathode, mixing an active material, and a conductive additive is carried out at a mixer blade tip speed in a range of 16 ms−1 to 20 ms⁻¹ for a time period in a range of 90 to 150 minutes.

In an embodiment of the present disclosure, there is provided a process for preparing an electrode, the process comprising: (a) mixing an active material, a conductive additive optionally with a first binder to obtain a first mixture; (b) blending a fibrillating binder with the first mixture at a temperature in a range of 0 to 30° C., at a mixer blade tip speed in a range of 9 ms⁻¹ to 11 ms⁻¹, followed by high shear mixing to obtain a second mixture; (c) quenching the second mixture and calendering to obtain the electrode. In another embodiment of the present disclosure, blending a fibrillating binder with the first mixture is carried out at a mixer blade tip speed in a range of 9 ms⁻¹ to 10 ms⁻¹ followed by high shear mixing to obtain a second mixture. In yet another embodiment of the present disclosure, blending a fibrillating binder with the first mixture is carried out at a mixer blade tip speed in a range of 10 ms⁻¹.

In an embodiment of the present disclosure, there is provided a process for preparing an electrode, the process comprising: (a) mixing an active material, a conductive additive optionally with a first binder to obtain a first mixture; (b) blending a fibrillating binder with the first mixture, followed by high shear mixing at a mixer blade tip speed in a range of 30 ms⁻¹ to 38 ms⁻¹ to obtain a second mixture; (c) quenching the second mixture with low shear mixing and calendering to obtain the electrode. In another embodiment of the present disclosure, high shear mixing is carried out at a mixer blade tip speed in a range of 32 ms⁻¹ to 36 ms⁻¹. In yet another embodiment of the present disclosure, when the electrode is an anode, high shear mixing is carried out at a mixer blade tip speed of 30 ms⁻¹. In still another embodiment of the present disclosure, when the electrode is a cathode, high shear mixing is carried out at a mixer blade tip speed of 35 ms⁻¹.

In an embodiment of the present disclosure, there is provided a process for preparing an electrode, wherein the high shear mixing is conducted at a temperature in a range of 50 to 85° C. via induced temperature or external heating means, and the external heating means is a fluid flow jacket.

In an embodiment of the present disclosure, there is provided a process for preparing an electrode, the process comprising: (a) mixing an active material, a conductive additive optionally with a first binder to obtain a first mixture; (b) blending a fibrillating binder with the first mixture at mixer blade tip speed in a range of 15 ms⁻¹ to 20 ms⁻¹, followed by high shear mixing and at an induced temperature in a range of 50 to 85° C. to obtain a second mixture; (c) quenching the second mixture with low shear mixing and calendering to obtain the electrode. In another embodiment of the present disclosure, the induced temperature is the temperature attained by the container of the mixture due to the heat generated while blending the fibrillating binder with the first mixture at high shear mixing at mixer blade tip speed in a range of 30 ms⁻¹ to 38 ms⁻¹.

In an embodiment of the present disclosure, there is provided a process for preparing an electrode, the process comprising: (a) mixing an active material, a conductive additive optionally with a first binder to obtain a first mixture; (b) blending a fibrillating binder with the first mixture at mixer blade tip speed in a range of 30 ms⁻¹ to 38 ms⁻¹, followed by high shear mixing at a temperature in a range of 50 to 85° C. by external heating to obtain a second mixture; (c) quenching the second mixture with low shear mixing and calendering to obtain the electrode. In another embodiment of the present disclosure, the temperature of the container is maintained between 50 to 85° C. by means of fluid flow jacket while blending the fibrillating binder with the first mixture at high shear mixing at mixer blade tip speed in a range of 30 ms⁻¹ to 38 ms⁻¹.

In an embodiment of the present disclosure, there is provided a process for preparing an electrode, the process comprising: (a) mixing an active material, a conductive additive optionally with a first binder to obtain a first mixture; (b) blending a fibrillating binder with the first mixture, followed by high shear mixing at mixer blade tip speed in a range of 30 ms⁻¹ to 38 ms⁻¹ and at an induced temperature in a range of 50 to 85° C. to obtain a second mixture; and (c) quenching the second mixture with low shear mixing at a mixer blade tip speed in a range of 6 to 11 ms⁻¹ and calendering to obtain the electrode. In another embodiment, quenching the second mixture is followed by subjecting to a continuous low shear mixing prior to calendering. In still another embodiment, the continuous low shear mixing is carried out at a mixer blade tip speed in a range of 8 to 10 ms⁻¹ and at a mixer blade tip speed in a range of 10 ms⁻¹.

In an embodiment of the present disclosure, there is provided a process for preparing an electrode, the process comprising: (a) mixing an active material, a conductive additive optionally with a first binder to obtain a first mixture; (b) blending a fibrillating binder with the first mixture, followed by high shear mixing to obtain a second mixture; and (c) quenching the second mixture at a temperature of 0 to 19° C. and optionally under a mixing tip speed in a range of 6 ms⁻¹ to 11 ms⁻¹ during or after quenching followed by calendering to obtain the electrode.

In an embodiment of the present disclosure, there is provided a process for preparing an electrode, the process comprising: (a) mixing an active material, a conductive additive optionally with a first binder to obtain a first mixture; (b) blending a fibrillating binder with the first mixture, followed by high shear mixing to obtain a second mixture; (c) quenching the second mixture at a temperature of 0 to 19° C. and optionally mixed at low tip speed in a range of 6 ms⁻¹ to 11 ms⁻¹ during or after quenching to improve flowability, followed by calendering to obtain the electrode.

In an embodiment of the present disclosure, there is provided a process for preparing an electrode, the process comprising: (a) mixing an active material, a conductive additive optionally with a first binder to obtain a first mixture; (b) blending a fibrillating binder with the first mixture, followed by high shear mixing to obtain a second mixture; (c) quenching the second mixture at a temperature of 0 to 19° C. and calendering at a temperature in a range of 60 to 200° C. to obtain the electrode with a throughput of 5 m/min. In another embodiment of the present disclosure, calendering is carried out with every adjacent roller maintained at different rotation speeds with a first roller speed of less than 50 rpm, and an nth set of roller speed of at least 80 rpm. In further embodiment, calendering is carried out with a roller speed difference in a range of 101-200% between every adjacent roller. In yet another embodiment, calendering is carried out with a roller speed difference in a range of 150-190% between every adjacent roller. In still another embodiment, calendering is carried out with a roller speed difference of 125% between every adjacent roller. In one another embodiment, calendering results in effective fibrillation and the shearing force required for the binder fibrillation is provided by the rollers by adjusting the speeds of the roller, wherein the rollers can be combined to achieve the required fibrillation and electrode film thickness.

In an embodiment of the present disclosure, there is provided a process for preparing an electrode, the process comprising: (a) mixing an active material, a conductive additive optionally with a first binder to obtain a first mixture; (b) blending a fibrillating binder with the first mixture, followed by high shear mixing to obtain a second mixture; and (c) quenching the second mixture is followed by fibrillating and calendering to obtain the electrode.

In an embodiment of the present disclosure, there is provided a process for preparing an electrode, the process comprising: (a) mixing an active material, a conductive additive optionally with a first binder to obtain a first mixture; (b) blending a fibrillating binder with the first mixture, followed by high shear mixing to obtain a second mixture; and (c) quenching the second mixture and calendering comprises fibrillating the second mixture to obtain the electrode.

In an embodiment of the present disclosure there is provided a process for preparing an electrode, the process comprising: (a) mixing an active material, a conductive additive optionally with a first binder to obtain a first mixture; (b) blending a fibrillating binder with the first mixture, followed by high shear mixing to obtain a second mixture; (c) quenching the second mixture and calendering to obtain the electrode, wherein the active material is an anode material or a cathode material; the first binder is selected from polyvinylidene fluoride (PVDF), poly(vinylidene fluoride-co-hexafluoropropylene) (PVDF-HFP), polyfluoroxy alkanes (PFA), polyvinyl fluoride (PVF), polyethylene (PE), polyethylene vinyl acetate (PEVA), polyurethane (PU), polypropylene rubber (PPR), ethylene propylene rubber (EPR), styrene butadiene rubber (SBR), styrene-ethylene butylene-styrene rubber (SEBS), acrylonitrile butadiene styrene Rubber (ABS), polyisobutylene (PIB), polyvinyl alcohol (PVA), phenoxy resin, polyethylene terephthalate (PET), nylon, polymethyl methacrylate (PMMA), polyvinyl chloride (PVC), polyphenylene sulphide (PPS), PEDOT: PSS, polystyrene (PS), pitch, tar, asphalt, or bitumen. cellulose, cellulose acetate, methylcellulose, ethyl cellulose, hydroxypropyl cellulose (HPC), hydroxyethyl cellulose (HEC), cellulose nitrate, carboxymethylcellulose (CMC), carboxyethyl cellulose, carboxypropyl cellulose, carboxyisopropyl cellulose, sodium cellulose, sodium cellulose nitrate, sodium carboxyalkyl cellulose or combinations thereof; the fibrillating binder is selected from polytetrafluoroethylene (PTFE), fluoroethylene vinyl ether (FEVE), polypropylene (PP), polyethylene oxide (PEO), fluorinated ethylene propylene (FEP), Polyacrylonitrile (PAN), Nanofiber CMC, cellulose nanofibers or combinations thereof; and the conductive additive is selected from graphene, single-walled carbon nanotube (SWCNT), multi-walled carbon nanotube (MWCNT), carbon black, ketjen black 600JD, acetylene black, Super P C45, Super P C65, Super P C65T, ketjen black 300 or combinations thereof. In another embodiment of the present disclosure, the first binder is polyvinylidene fluoride (PVDF); the fibrillating binder is polytetrafluoroethylene (PTFE); the conductive additive is carbon black super P C65.

In an embodiment of the present disclosure, there is provided a process for preparing an electrode, the process comprising: (a) mixing an active material, a conductive additive optionally with a first binder to obtain a first mixture; (b) blending a fibrillating binder with the first mixture, followed by high shear mixing to obtain a second mixture; wherein the active material is an anode material or a cathode material; the anode material is selected from natural graphite, synthetic graphite, silicon-graphite composite, silicon-carbon composite, hard carbon, soft carbon, mixture of natural and synthetic graphite, mixture of synthetic, natural graphite and silicon, mixture of any types of graphite with hard and soft carbon, lithium-titanium-oxide (LTO), LTO composites or combinations thereof; and the cathode material is selected from lithium cobalt oxide (LCO), lithium manganese oxide (LMO), lithium iron phosphate (LFP), lithium yttrium iron phosphate (LYP), lithium nickel manganese cobalt oxide, nickel rich lithium nickel manganese cobalt oxide, lithium nickel cobalt aluminium oxide (NCA), lithium nickel manganese oxide (LNMO), lithium manganese phosphate (LiMnPO₄), lithium cobalt phosphate (LiCoPO₄), lithium vanadium phosphate (LVP) or combinations thereof. In another embodiment of the present disclosure, wherein the anode material is graphite.

In an embodiment of the present disclosure, there is provided a process for preparing an electrode, the process comprising: (a) mixing an active material, a conductive additive optionally with a first binder to obtain a first mixture; (b) blending a fibrillating binder with the first mixture, followed by high shear mixing to obtain a second mixture; (c) quenching the second mixture, followed by fibrillating and calendering to obtain the electrode, wherein the fibrillating is performed in an extruder.

In an embodiment of the present disclosure, there is provided a process for preparing an electrode, the process comprising: (a) mixing an active material, a conductive additive optionally with a first binder to obtain a first mixture; (b) blending a fibrillating binder with the first mixture, followed by high shear mixing to obtain a second mixture; (c) quenching the second mixture, followed by fibrillating and calendering to obtain the electrode.

In an embodiment of the present disclosure, there is provided a process for preparing an electrode, the process comprising: (a) mixing an active material, a conductive additive optionally with a first binder to obtain a first mixture; (b) blending a fibrillating binder with the first mixture, followed by high shear mixing to obtain a second mixture; (c) quenching the second mixture and calendering to obtain the electrode, wherein the active material is in a weight range of 88 to 98% with respect to total weight of the electrode; the conductive additive is in a weight range of 0.5 to 4% with respect to total weight of the electrode; the first binder is in a weight range of 0.5 to 4% with respect to total weight of the electrode; and the fibrillating binder is in a weight range of 0.5 to 4% with respect to total weight of the electrode. In another embodiment of the present disclosure, wherein the active material is in a weight range of 90 to 97% with respect to total weight of the electrode; the conductive additive is in a weight range of 0.5 to 2% with respect to total weight of the electrode; the first binder is in a weight range of 0.5 to 2% with respect to total weight of the electrode; and the fibrillating binder is in a weight range of 0.5 to 2% with respect to total weight of the electrode.

In an embodiment of the present disclosure there is provided a process for preparing an electrode, the process comprising: (a) mixing an active material, a conductive additive optionally with a first binder to obtain a first mixture; (b) blending a fibrillating binder with the first mixture, followed by high shear mixing to obtain a second mixture; (c) quenching the second mixture and calendering in the presence of a current collector to obtain the electrode.

In an embodiment of the present disclosure, there is provided a process for preparing an electrode, the process comprising: (a) mixing an active material, a conductive additive optionally with a first binder to obtain a first mixture; (b) blending a fibrillating binder with the first mixture, followed by high shear mixing to obtain a second mixture; (c) quenching the second mixture and calendering in the presence of a current collector selected from copper foil, aluminium foil, carbon coated copper aluminium foils, primer coated copper aluminium foils, glossy copper foils, glossy aluminium foils, or combinations thereof to obtain the electrode.

In an embodiment of the present disclosure, there is provided an electrode obtained by the process as disclosed herein. In another embodiment of the present disclosure, there is provided an electrode obtained by the process as disclosed herein, wherein the electrode is an anode. In yet another embodiment of the present disclosure, the electrode is a cathode.

In an embodiment of the present disclosure, there is provided a use of the electrode as disclosed herein, as a working electrode in an electrochemical cell. In another embodiment of the present disclosure, there is provided a use of the electrode as disclosed herein, as a working electrode in an electrochemical cell for application in batteries.

In an embodiment of the present disclosure, there is provided a first electrochemical cell comprising: (a) an anode comprising the electrode obtained by the process as disclosed herein; (b) a cathode; and (c) an electrolyte.

In an embodiment of the present disclosure, there is provided a first electrochemical cell comprising: (a) an anode; (b) a cathode comprising the electrode obtained by the process as disclosed herein; and (c) an electrolyte.

In an embodiment of the present disclosure, there is provided a modified electrochemical cell comprising: (a) an anode comprising the electrode obtained by the process as disclosed herein; (b) a cathode comprising the electrode obtained by the process as disclosed herein; and (c) an electrolyte.

In an embodiment of the present disclosure, there is provided a use of the electrode obtained by the process disclosed herein as a working electrode in an electrochemical cell. In another embodiment, there is provided a use of the electrode obtained by the process as disclosed herein as an anode or a cathode in an electrochemical cell.

Although the subject matter has been described in considerable detail with reference to certain examples and implementations thereof, other implementations are possible.

### EXAMPLES

The disclosure will now be illustrated with working examples, which is intended to illustrate the working of disclosure and not intended to take restrictively to imply any limitations on the scope of the present disclosure. Unless defined otherwise, all technical and scientific terms used herein have the same meaning as commonly understood to one of ordinary skill in the art to which this disclosure belongs. Although methods and materials similar or equivalent to those described herein can be used in the practice of the disclosed methods and compositions, the exemplary methods, devices, and materials are described herein. It is to be understood that this disclosure is not limited to particular methods, and experimental conditions described, as such methods and conditions may apply.

### Materials and Methods

The various chemicals and solvents used in the present disclosure are as follows:
a. Active Component:
   i. Anode active material-Natural Graphite (Imerys GHDR 15-4), synthetic graphite
   ii. Cathode material
b. Conductive material-Super P (Imerys Super C65T)
c. First binder
   i. Polyvinylidene fluoride (PVDF) (Arkema HSV900)
   ii. Carboxy methyl cellulose (CMC)
d. Fibrillating binder-Polytetrafluoroethylene (PTFE) (GFL Inoflon LB3000)

### Example 1

### Preparation of the Electrode Composition—Method 1

The present example explains the process of preparing the electrode. Active material, conductive carbon, non-fibrillating binder (first binder) and fibrillating binder were taken in the weight ratio of 96:1:1.5:1.5. In the first step, the (active material) graphite (Zichen QC-8F) and super P (conductive carbon) were premixed at a mixer blade tip speed of 15 ms⁻¹ for 15 minutes maintaining a temperature range of 15 to 25° C. to obtain a first mixture. Conductive carbon coating was carried out to achieve higher electron conductivity.

Followed by this, in the second step, the (non-fibrillating first binder) polyvinylidene fluoride (PVDF) was added to this first mixture and mixed for another 15 minutes maintaining the same temperature range to obtain the second mixture. In the third step, polytetrafluoroethylene (PTFE) (fibrillating binder) was added to the above second mixture and blended for another 15 min in the temperature range of 15-25° C. The non-fibrillating first binder was added to insulate PTFE (fibrillating binder) from active material and conductive carbon, also to provide better adhesion to current collector. Temperature was maintained below 19° C. so as to preserve high density PTFE phase. The temperature was maintained below 19° C. to curtail premature fibrillation of PTFE before getting distributed into the active material. At or above 19° C., the PTFE undergoes first phase transition, which will lead to the agglomeration of the PTFE.

After the three stages of premixing, mixing, and blending, a high shear mixing was carried out at a mixer blade tip speed of 33 ms⁻¹ until the temperature of the mixture was raised up to 70° C. High shear mixing facilitated unwinding of the interconnected spherulites in order to fibrillate the PTFE binder. Once the temperature reached 70° C., the shear mixing was stopped, and the mixture was super-cooled to a temperature of 15° C. Followed by this, PTFE coated active material was compacted by calendering at a temperature of 150° C. to achieve the spherulite interconnection. A high temperature was required to activate the primer coating in the current collector. In the case of large-scale manufacturing, the calendering temperature would be around 200° C. If the high shear mixing was stopped at a temperature of 30-50° C., the process did not result in a stable electrode film.

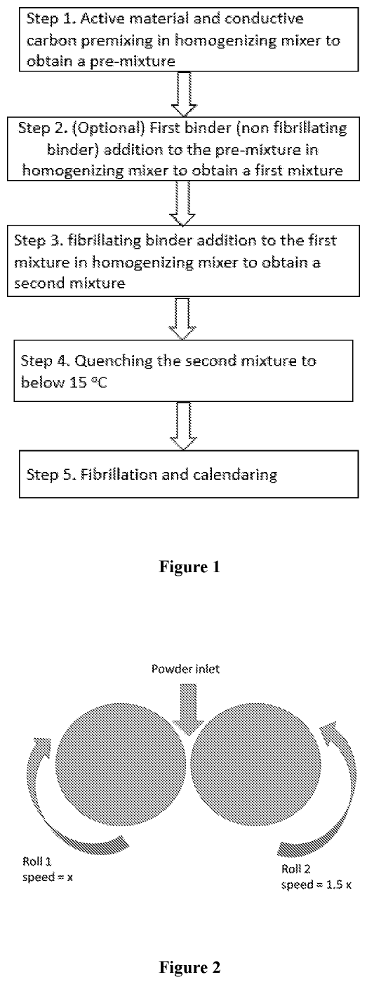

The various examples employing the different materials for the method as provided above are explained herein. Active material and conductive additive were mixed in homogenizing mixer for a time period of 5 to 30 minutes at a temperature of 0 to 30° C. and with a mixer blade tip speed of 11 ms⁻¹ to obtain the first mixture. The first mixture was cooled to a temperature below 15° C., and the fibrillating binder PTFE was added under mixing for a time period of 5 to 90 minutes at a temperature of 0 to 15° C. and at a mixer blade tip speed of 10 ms⁻¹ to 11 ms⁻¹, followed by high shear mixing at a mixer blade tip speed of 33 ms⁻¹. During the PTFE addition, the tip speed of the blade of the Zeppelin mixer was adjusted with the tip speed in a range of 20 ms⁻¹ to 38 ms⁻¹ to obtain the second mixture. Then the second mixture was cooled to a temperature in a range of 0 to 19° C. and subjected to fibrillation in a screw extruder and calendering at a temperature of 80° C. and at a roller speed in a range of 0.1 to 5 ms⁻¹ with a roller speed difference of 175% between two rollers to obtain the electrode A. FIG. 1 depicts the processes of preparation of the electrode as disclosed herein.

Active material and conductive additive was mixed in homogenizing mixer for a time period of 5 to 30 minutes at a temperature of 0 to 30° C. and at a mixer blade tip speed of 10 ms⁻¹ to 20 ms⁻¹ to obtain a mixture. To this mixture, the first binder PVDF was added for a time period of 15 minutes, at a temperature of 0 to 30° C. and mixed with a mixer blade tip speed of 15 ms⁻¹ in homogenizing mixer to obtain the first mixture. The first mixture was cooled to a temperature below 15° C., and the fibrillating binder was added under blending for a time period of 5 to 90 minutes, at a temperature of 0 to 15° C., at a mixer blade tip speed of 10 ms⁻¹, followed by high shear mixing at a mixer blade tip speed of 30 to 38 ms⁻¹ to obtain the second mixture. Then the second mixture was quenched at a mixer blade tip speed of 11 ms⁻¹ and was subjected to fibrillation in a screw extruder and calendering at a temperature of 80° C., at a roller speed in a range of 0.1 to 5 mmin⁻¹ with roller speed difference of 175% between two rollers with a throughput of 5 m/min to obtain the electrode B.

In an example, an anode is prepared by the process as explained herein. Graphite and conductive carbon was mixed in a homogenizing mixer for a time period of 10 minutes at a temperature of 15° C. and at a mixer blade tip speed of 20 ms⁻¹. To this mixture, the first binder (PVDF or CMC) was added for a time period of 30 minutes at a temperature of below 30° C., at a mixer blade tip speed of 11 ms⁻¹ in a homogenizing Zeppelin mixer to obtain the first mixture. To this first mixture, the fibrillating binder (PTFE) was added under blending at a mixer blade tip speed of 11 ms⁻¹ for a time period of 10 minutes at a temperature of 15° C., followed by high shear mixing at a mixer blade tip speed of 33 ms⁻¹ to obtain the second mixture. Then the second mixture was subjected to fibrillation by calendering at a temperature of 80° C., at a roller speed in a range of 0.1 to 5 m min⁻¹ with roller speed difference of 125% and with a throughput of 5 m min⁻¹ to obtain the anode. FIG. 2 depicts the pictorial representation of the rollers used for the calendering process which comprises binder fibrillation.

The process was carried out optionally in the presence of a current collector while calendering so that the electrode mixture was coated on the current collector and to obtain the anode.

In another example high shear mixing at a blade tip speed of 33 ms⁻¹ was carried until the wall temperature of the container comprising the mixture reached a temperature of 50 to 85° C. Further, the calendering was also carried out at 150° C. resulted in effective fibrillation of the electrode material mixture.

Table 1 below describes the process of preparing the electrode and various advantages in maintaining the specific parameters as disclosed herein.

TABLE 1

| | | Tip | | Wall | | |
|---|---|---|---|---|---|---|
| | Process | speed | Time | Temp | | |
| No | Parameters | (ms⁻¹) | (min) | ° C. | Remarks | Significance |
| 1 | Active | 11 | 15 | 15-<25 | 1. Water | Ensured homogenous mixing of |
| | material | | | | inside the | active material with CC and B1 |
| | (AM) + | | | | jacket was | |
| | Conducting | | | | approx. | |
| | Carbon (CC) | | | | 25° C. | |
| | premixing | | | | 2. Chiller - | |
| | | | | | OFF | |
| 2 | (AM + CC) + | 11 | 15 | 15-<25 | Addition of | Ensured homogenous mixing of |
| | First | | | | PVDF | PVDF. If the temperature |
| | binder (B1) | | | | binder | reached beyond 25° C., PVDF got |
| | premixing | | | | | sticky and formed |
| | | | | | | agglomerations |
| 3 | AM + CC + | 11 | 15 | 15-<25 | Addition of | Ensured homogenous mixing |
| | B1 + | | | | PTFE | with PTFE |
| | fibrillating | | | | binder | |
| | binder (B2) | | | | | |
| | premixing | | | | | |
| 4 | High Shear | 33 | | 65 | Ramp up to | High tip speed facilitated PTFE |
| | Mixing | | | | 65° C. | fibrillation as there was an |
| | | | | | (Limiting by | increase in the temperature. PTFE |
| | | | | | temperature) | fibrillated between 50-70° C. |
| 4 | High Shear | 33 | | 70 | Once | Ensured maximum effectiveness |
| | Mixing | | | | temperature | of fibrillation and maximum |
| | | | | | reached | elongation of PTFE fibrils. |
| | | | | | 70° C., the | |
| | | | | | mixing was | |
| | | | | | stopped. | |
| 5 | Quenching | 0 | | 16 | Low shear | The cooling rate determined |
| | | | | | mixing | crystallinity of the heat-treated |
| | | | | | while | PTFE monofilament. The higher |
| | | | | | cooling | the degree of crystallinity was, |
| | | | | | down | the higher strength of the PTFE |
| | | | | | (Chiller on | ad fibrils obtained in subsequent |
| | | | | | at 10° C.) | process was stronger, and the |
| | | | | | | defects of the fiber in a |
| | | | | | | longitudinal direction decreased, |
| | | | | | | This decreased fluctuation in |
| | | | | | | strength of the fiber remarkably. |
| 6 | Calendering | 1-2 | | 150 | | When calendering, the fibrils |
| | | RPM | | | | were uniformly formed at each |
| | | | | | | area/m² in the film. |
| | Calendering | | | 80 | | |
| | roll speed 0.1 | | | | | |
| | to 5.0 m min⁻¹ | | | | | |

Cathode was also prepared by the process as explained herein. Cathode active material and conductive carbon was mixed in homogenizing mixer for a time period of 30 minutes at a temperature of 0 to 30° C. and at a blade tip speed of 18 ms⁻¹ to obtain the first mixture. To this first mixture, the fibrillating binder was added under blending for a time period of 120 minutes at a temperature of 0 to 15° C., at a mixer blade tip speed of 33 ms⁻¹, followed by high shear mixing at a mixer blade tip speed in a range of 38 ms⁻¹, to obtain the second mixture. Then the second mixture was quenched at a mixer blade tip speed in a range of 11 ms⁻¹, low shear mixed at a mixer blade tip speed of 11 ms⁻¹ and was calendered at a temperature of 80° C. and at a roller speed in a range of 0.1 to 5 m min⁻¹ with roller speed difference of 125% between two rollers with a throughput of 5 m min⁻¹ to obtain the cathode.

The process was carried out optionally in the presence of a current collector while calendering so that the electrode mixture was coated on the current collector and to obtain the cathode.

The process was also performed to prepare cathode from a cathode active material. For the preparation of the cathode, use of the first binder was optional.

### Preparation of Electrochemical Cell

An electrochemical cell was prepared using the anode as prepared by the process explained in example 1, a lithium-based cathode, an electrolyte, and a separator.

### Example 2

### Analysis of Process Temperature in the Ability of Forming Electrode in the Form of a Film:

The film forming ability of electrode mixtures depends on the process temperature. To demonstrate the effect of temperature, two electrodes were obtained by the process as disclosed herein by varying the temperature at which high shear mixing was carried out (˜30° C. and 70° C.) while maintaining the process parameters (table 2 a) and electrode composition (table 2 b) identical to obtain corresponding second mixtures.

TABLE 2a
Process Parameters for obtaining the second mixtures.

| | | | Wall Temp ° C. | |
|---|---|---|---|---|
| | | | High | Low |
| | | | Temperature | Temperature |
| Process | | Time | Process | Process |
| Parameters | RPM | (min) | (70° C.) | (30° C.) |
| AM + CC | 1000 | 15 | 13.5 | 13.7 |
| (Premixing) | | | | |
| (AM + CC) + B1 | 1000 | 15 | 13.3 | 13.3 |
| (Premixing) | | | | |
| (AM + CC + B1) + | 1000 | 15 | 13.7 | 13.3 |
| B2 (Premixing) | | | | |
| High shear | 3000 | 12 | 70 | 32 |
| Mixing | | | | |

TABLE 2b
Electrode (Anode) Composition of the second mixtures

| Electrode | | Composition | Quantity |
|---|---|---|---|
| composition | Materials | (wt. %) | (g) |
| Anode active | Natural | 96 | 2880 |
| material (AM) | Graphite | | |
| Conductive Carbon (CC) | Super P | 1 | 30 |
| First Binder (B1) | PVDF | 1.5 | 45 |
| Second Binder (B2) | PTFE | 1.5 | 45 |

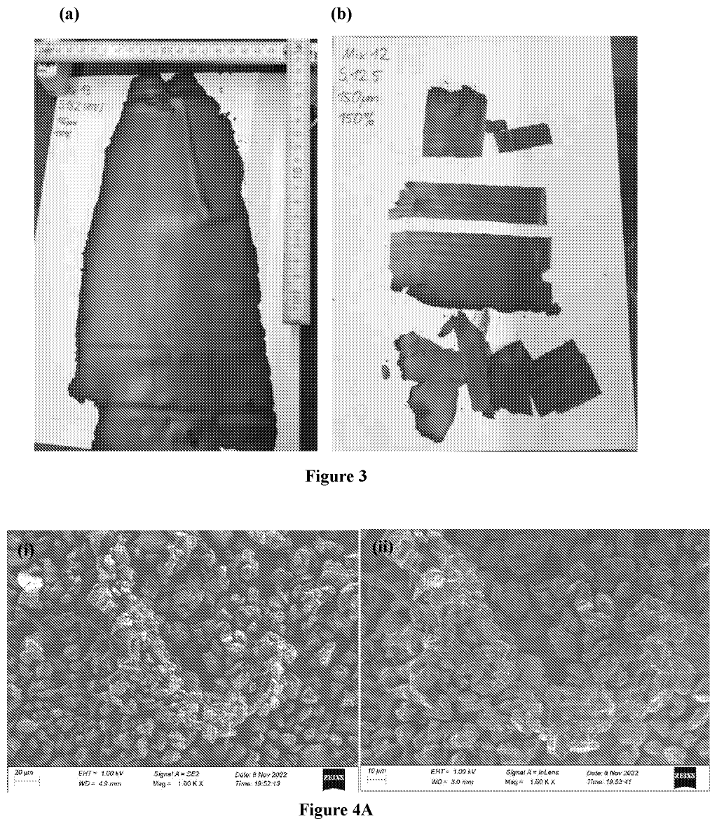

The obtained second mixtures were then quenched followed by subjecting to a single step gap-controlled calendaring with 150-micron gap and 150% shear to obtain the electrodes. While the high temperature process carried out at 70° C. resulted in a stable flexible film as shown in FIG. 3(a), the film formed by the above process at low temperature was found to be brittle as shown in FIG. 3(b), indicating the importance of high shear mixing temperature. Further, even though a comparably stable thin film was possible to be obtained at low temperature, it required greater time for mixing. Hence, the high shear mixing process temperature was optimized to be at least 70° C.

### Example 3

### SEM Analysis of the Electrode Materials

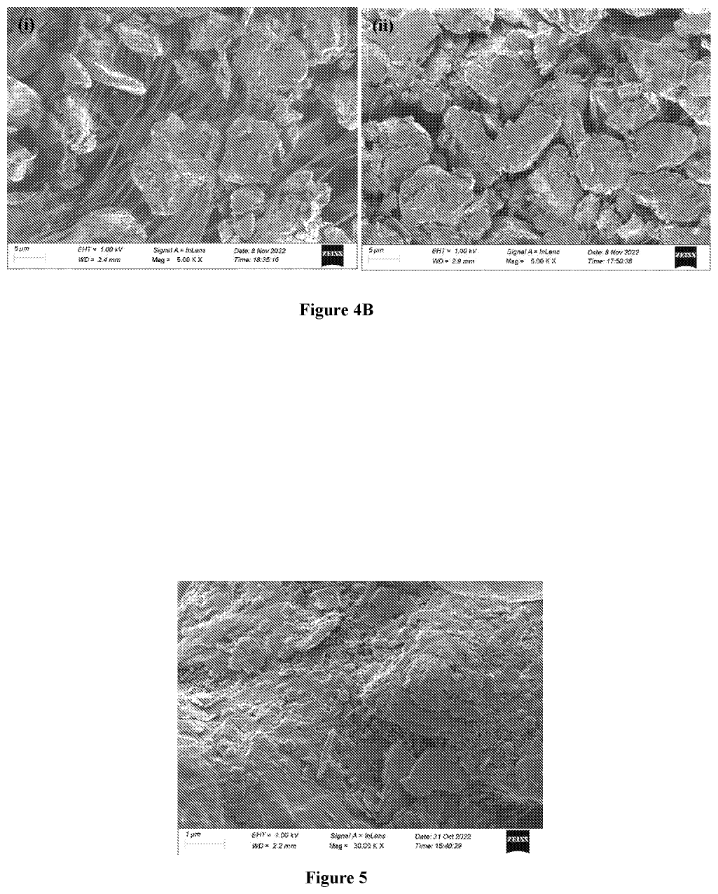

The topography of the sample electrode materials prepared from the processes disclosed herein was analyzed. The scanning electron microscopic (SEM) images for the sample electrode materials prepared by the process method 1, before and after calendering process are shown in FIG. 4A and FIG. 4B respectively.

The SEM images of the samples showed that the fibril formation in the electrode material was formed only after the calendering step and not immediately after the high shear mixing step. Hence the fibrillation was initiated during the calendering process after the high shear mixing until the temperature of the mixture was raised up to 70° C.

SEM image was taken for the mixture where the temperature was not controlled and went above 85° C., and above 90° C. Said image is shown in FIG. 5. It could be inferred that the binder's phase changed and was sticking to the material, and the material in turn was found to stick to the equipment. Therefore, it is essential that the temperature range in each sequential addition be maintained within said ranges for obtaining an effective electrode material.

### Example 4

### Electrochemical Results

The electrode compositions prepared were subjected to electrochemical analysis. The electrochemical analysis results of the cells prepared the processes as explained in example 1 is given in table 3. The charge-discharge cycles of the cells were assessed at the rate of 0.1C/0.1C. The capacity of the cells is given in the scale of mAh/g and the efficiency with respect to the charge-discharge capacities were measured and compared with that of the conventionally prepared cells. The results showed that the cells prepared from the processes disclosed herein exhibited an efficiency equivalent to that of the conventional cells. The efficiency for the cell prepared by the process as explained in example 1, was found to be around ˜90% in the first cycle and ˜99% in the second cycle.

TABLE 3

| Charge- | | Cell 1 | | | Cell 2 | | |
|---|---|---|---|---|---|---|---|
| discharge | | Capacity (mAh/g) | | | Capacity (mAh/g) | | |
| Rate | Cycle | Charge | Discharge | Efficiency % | Charge | Discharge | Efficiency % |
| 0.1 C/0.1 C | 1^{st} Cycle | 350.34 | 375.33 | 93.34 | 362.35 | 389.93 | 92.93 |
| 0.1 C/0.1 C | 2^{nd} Cycle | 347.41 | 350.40 | 99.15 | 358.99 | 362.26 | 99.10 |

### Advantages of the Present Disclosure:

The present disclosure provides a facile process of preparing dry electrodes such as anodes and cathodes. The process of the present disclosure incurs less cost, consumes less energy and are economically viable processes. The present disclosure provides a process of preparing dry electrode which does not involve use of any solvent. The process of the present disclosure involves sequential low shear mixing, high shear mixing and calendaring to achieve effective fibrillation of the binder. The electrode prepared by the process of the present disclosure therefore exhibits improved electrochemical efficiency. The process of the present disclosure is suitable for preparing an anode as well as a cathode. Further, the electrochemical cells prepared using the electrodes prepared by the process of the present disclosure exhibits an efficiency of electrochemical capacity of about ˜80% to ˜99%.

1.-24. (canceled)

25. A process for preparing an electrode, the process comprising:
a. mixing an active material, and a conductive additive optionally with a first binder to obtain a first mixture;
b. blending a fibrillating binder with the first mixture, followed by high shear mixing to obtain a second mixture; and
c. quenching the second mixture and calendering to obtain the electrode.

26. The process as claimed in claim 25, wherein mixing an active material, and a conductive additive optionally with a first binder is carried out at a temperature in a range of 0 to 30° C., and at a mixer blade tip speed in a range of 11 to 20 ms⁻¹ for a time period ranging from 10 to 180 min; and blending the fibrillating binder with the first mixture is carried out at a temperature in a range of 0 to 30° C., at a mixer blade tip speed in a range of 9 to 11 ms⁻¹.

27. The process as claimed in claim 25, wherein the high shear mixing comprises mixing at mixer blade tip speed in a range of 30 to 38 ms⁻¹.

28. The process as claimed in claim 25, wherein the high shear mixing is conducted at a temperature in a range of 50 to 85° C.

29. The process as claimed in claim 25, wherein the high shear mixing is conducted at an induced temperature in a range of 50 to 85° C.

30. The process as claimed in claim 25, wherein the high shear mixing is conducted at a temperature in a range of 50 to 85° C., said temperature provided by an external heating means.

31. The process as claimed in claim 25, wherein quenching the second mixture is performed at a temperature of 0 to 19° C. and optionally under a mixer blade tip speed in a range of 6 to 11 ms⁻¹ during or after quenching.

32. The process as claimed in claim 25, wherein quenching the second mixture is followed by subjecting to a continuous low shear mixing prior to calendering.

33. The process as claimed in claim 32, wherein the continuous low shear mixing is carried out at a mixer blade tip speed in a range of 5 to 11 ms⁻¹.

34. The process as claimed in claim 25, wherein calendering is done at a temperature in a range of 60 to 200° C.

35. The process as claimed in claim 25, wherein quenching the second mixture followed by fibrillating and calendering to obtain the electrode.

36. The process as claimed in claim 25, wherein calendering comprises fibrillating the second mixture under shear force; and the shearing force is obtained with a roller speed difference in a range of 101-200% between two adjacent rollers.

37. The process as claimed in claim 25, wherein the first binder is selected from polyvinylidene fluoride (PVDF), poly(vinylidene fluoride-hexafluoropropylene) (PVDF-HFP), polyfluoroxy alkanes (PFA), polyvinyl fluoride (PVF), polyethylene (PE), polyethylene vinyl acetate (PEVA), polyethylene glycol (PEG), polyurethane (PU), polypropylene rubber (PPR), ethylene propylene rubber (EPR), styrene butadiene rubber (SBR), styrene-ethylene-butylene-styrene rubber (SEBS), acrylonitrile butadiene styrene Rubber (ABS), polyisobutylene (PIB), polyvinyl alcohol (PVA), phenoxy resin, polyethylene terephthalate (PET), nylon, polymethyl methacrylate (PMMA), polyvinyl chloride (PVC), polyphenylene sulphide (PPS), poly(3,4-ethylenedioxythiophene) polystyrene sulfonate (PEDOT:PSS), polystyrene (PS), pitch, tar, asphalt, bitumen, cellulose, cellulose acetate, methylcellulose, ethyl cellulose, hydroxypropyl cellulose (HPC), hydroxyethyl cellulose (HEC), cellulose nitrate, carboxymethylcellulose (CMC), carboxyethyl cellulose, carboxypropyl cellulose, carboxyisopropyl cellulose, sodium cellulose, sodium cellulose nitrate, sodium carboxyalkyl cellulose, or combinations thereof; the fibrillating binder is selected from polytetrafluoroethylene (PTFE), fluoroethylene vinyl ether (FEVE), polypropylene (PP), polyethylene oxide (PEO), fluorinated ethylene propylene (FEP), polyacrylonitrile (PAN), fluoropolymer blend, nanofiber carboxy methyl cellulose (CMC), cellulose nanofibers, or combinations thereof; the conductive additive is selected from graphene, single walled carbon nanotube (SWCNT), multiwalled carbon nanotube (MWCNT), carbon black, ketjen black 600JD, acetylene black, Super P C45, Super P C65, Super P C65T, ketjen black 300, or combinations thereof; the active material is an anode material or a cathode material; the anode material is selected from natural graphite, synthetic graphite, silicon-graphite composite, silicon-carbon composite, hard carbon, soft carbon, transition metal oxides, lithium titanium oxide (LTO), LTO composites, or combinations thereof; and the cathode material is selected from lithium cobalt oxide (LCO), lithium manganese oxide (LMO), lithium iron phosphate (LFP), lithium yttrium iron phosphate (LYP), lithium nickel manganese cobalt oxide, nickel rich lithium nickel manganese cobalt oxide, lithium nickel cobalt aluminium oxide (NCA), lithium nickel manganese oxide (LNMO), lithium manganese phosphate (LiMnPO4), lithium cobalt phosphate (LiCoPO4), lithium vanadium phosphate (LVP), LiMn2O4, spinel type alkali metal transition metal oxides, phosphate type cathode materials such as LiFePO4, LiNi0.8Mn0.1Co0.1O2, alkali-transition metal oxides (AMO2) oxides, or combinations thereof.

38. The process as claimed in claim 25, wherein the active material is in a weight range of 88 to 98% with respect to total weight of the electrode; the conductive additive is in a weight range of 0.5 to 4% with respect to total weight of the electrode; the first binder is in a weight range of 0.5 to 4% with respect to total weight of the electrode; and the fibrillating binder is in a weight range of 0.5 to 4% with respect to total weight of the electrode.

39. The process as claimed in claim 25, wherein calendering is performed in the presence of a current collector selected from copper foil, aluminium foil, carbon coated copper aluminium foils, primer coated copper aluminium foils, glossy copper foil, glossy aluminium foil, or combinations thereof.

40. The process as claimed in claim 25, wherein the electrode is an anode or a cathode.

41. An electrode obtained by the process as claimed in claim 25.

42. A first electrochemical cell comprising:
a. an anode comprising the electrode obtained by the process as claimed in claim 25;
b. a cathode; and
c. an electrolyte.

43. A second electrochemical cell comprising:
a. an anode;
b. a cathode comprising the electrode obtained by the process as claimed in claim 25; and
c. an electrolyte.

44. An electrochemical cell comprising:
a. an anode comprising the electrode obtained by the process as claimed in claim 25;
b. a cathode comprising the electrode obtained by the process as claimed in claim 25; and
c. an electrolyte.
